(19) United States
(12) Patent Application Publication
(10) Pub. No.: US 2006/0274038 A1
(43) Pub. Date: Dec. 7, 2006

(54) Menu input apparatus and method using camera of mobile communications terminal

(75) Inventors: Victor V. Redkov, St. Petersburg (RU); Anatoly I. Tikhotsky, St. Petersburg (RU); Sergey S. Karmanenko, St. Petersburg (RU)

Correspondence Address: BIRCH STEWART KOLASCH & BIRCH, PO BOX 747, FALLS CHURCH, VA, 22040-0747, US

(73) Assignee: LG Electronics Inc., Seoul (KR)

(21) Appl. No.: 11/439,174

(22) Filed: May 24, 2006

(30) Foreign Application Priority Data
May 24, 2005 (KR) 10-2005-0043866

(51) Int. Cl. G09G 5/08

(52) U.S. Cl. 345/157

(57) ABSTRACT

A menu input method for a mobile terminal including displaying a menu having a plurality of items on a display of the mobile terminal, displaying a cursor used to select one of the plurality of items at a first position on the display, capturing images of a pointer object moving in front of an image capturing device included with the mobile terminal, and converting the captured images into coordinate values of the cursor and moving the cursor to a second position on the display based on the converted coordinate values

This application claims priority to Korean Patent Application No. 10-200-0043866 filed on May 24, 2005, in Korea, the entire contents of which is hereby incorporated by reference in its entirety.

### BACKGROUND OF THE INVENTION

1. Field of the Invention

The present invention relates to a mobile communication terminal, and more particularly, to a menu input apparatus and method that uses a camera included in the mobile terminal to detect a pointer object moved in front of the camera to thereby navigate between items in a menu.

2. Background of the Related Art

A mobile communication terminal has become an essential item for many users. The mobile terminal provides various functions in addition to regular voice communication capabilities such as an electronic organizer, games, music (MP3) playback, an electronic dictionary, a digital camera, etc.

In addition, the mobile terminal also includes a Graphic User Interface (GUI) including a plurality of different menus allowing the user to navigate through various options to select a particular function. In more detail, the user generally presses a particular key or button (e.g., a shift or direction key) on a keypad to navigate through the various menu options to thereby select a particular function.

However, the user generally has to press the shift or direction key several times to select a particular menu option, which is inconvenient. In addition, a separate button for moving between the different options is required.

### SUMMARY OF THE INVENTION

Therefore, one object of the present invention is to provide a two-dimensional or three-dimensional GUI for providing a plurality of items or functions that can be selected by a user.

Another object of the present invention is allow the user to move a cursor or pointing device included with the GUI using the camera included with the mobile terminal.

To achieve these and other advantages and in accordance with the purpose of the present invention, as embodied and broadly described herein, there is provided in one aspect a menu input method for a mobile terminal, which includes displaying a menu having a plurality of items on a display of the mobile terminal, displaying a cursor used to select one of the plurality of items at a first position on the display, capturing images of a pointer object moving in front of an image capturing device included with the mobile terminal, and converting the captured images into coordinate values of the cursor and moving the cursor to a second position on the display based on the converted coordinate values.

In another aspect, there is provided a mobile terminal including a display configured to display a menu having a plurality of items on a display of the mobile terminal, and to display a cursor used to select one of the plurality of items at a first position on the display, an image capturing device configured to capture images of a pointer object moving in front of the image capturing device, and a processor configured to convert the captured images into coordinate values of the cursor and move the cursor to a second position on the display based on the converted coordinate values.

Further scope of applicability of the present invention will become apparent from the detailed description given hereinafter. However, it should be understood that the detailed description and specific examples, while indicating preferred embodiments of the invention, are given by illustration only, since various changes and modifications within the spirit and scope of the invention will become apparent to those skilled in the art from this detailed description.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is block diagram of a menu input apparatus in accordance wtih an embodiment of the present invention;

FIG. 2A is an overview illustrating a cursor positioned on an menu screen of a terminal in accordance with an embodiment of the present invention;

FIG. 2B is an overview illustrating a user moving his or her finger across a camera mounted to the terminal to thereby move the cursor in FIG. 2A in accordance with an embodiment of the present invention;

FIGS. 3A and 3B are overviews illustrating the cursor being moved by the user in a top-to-bottom direction in accordance with an embodiment of the present invention;

FIGS. 3C and 3D are overviews illustrating the cursor being moved by the user in a left-to-right direction in accordance with an embodiment of the present invention;

FIGS. 4A and 4B are overviews illustrating the cursor being moved by the user in a bottom-to-top direction in accordance with an embodiment of the present invention;

FIG. 4C is an overview illustrating a screen displayed on a display of the mobile terminal when the user moves and selects an item on a menu to instruct operation of the selected item;

FIG. 5A is an overview illustrating a 3-D GUI in accordance with an embodiment of the present invention;

FIG. 5B is an overview illustrating a user using moving his or her finger in three axial directions of X, Y and Z in front of a camera included with the mobile terminal to thereby move between menu blocks and to move a cursor in accordance with an embodiment of the present invention;

FIG. 6A is an overview illustrating a menu screen in accordance with an embodiment of the present invention;

FIG. 6B is an overview illustrating an input button combined with the camera in accordance with an embodiment of the present invention; and

FIG. 7 is a flowchart illustrating a method for moving a cursor on a menu screen and selecting a specific item using a camera included with the mobile terminal in accordance with an embodiment of the present invention.

### DETAILED DESCRIPTION OF THE INVENTION

Reference will now be made in detail to embodiments of the present invention, examples of which are illustrated in the accompanying drawings.

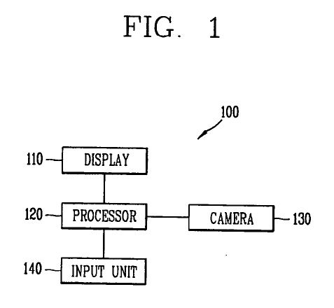

The present invention allows a user to move a cursor on a menu using a camera included with the mobile terminal. The present invention also provides a 2-D or 3-D GUI. In more detail, FIG. 1 is a block diagram illustrating a menu input apparatus 100 allowing the user to move his or her finger across a camera included with the mobile terminal to thereby move a cursor provided on the 2-D or 3D menu. As shown, the menu input apparatus 100 includes a display 110 for displaying a menu screen containing at least one or more items, a camera 130 (or other type of image capturing device, movement sensor, light detector, etc.) for capturing or detecting a movement of a pointer object such as the user's finger, a processor 120 for converting the movement of the pointer object captured with the camera 130 into a movement of the cursor, and an input unit 140 for selecting a specific item on the menu screen when the cursor has been moved over the specific item and the item has been highlighted. Hereinafter, the pointer object will be referred to as the user's finger. However, any other type of pointer object may be used (e.g., the user's palm, a pen or pencil, a stylus, etc.).

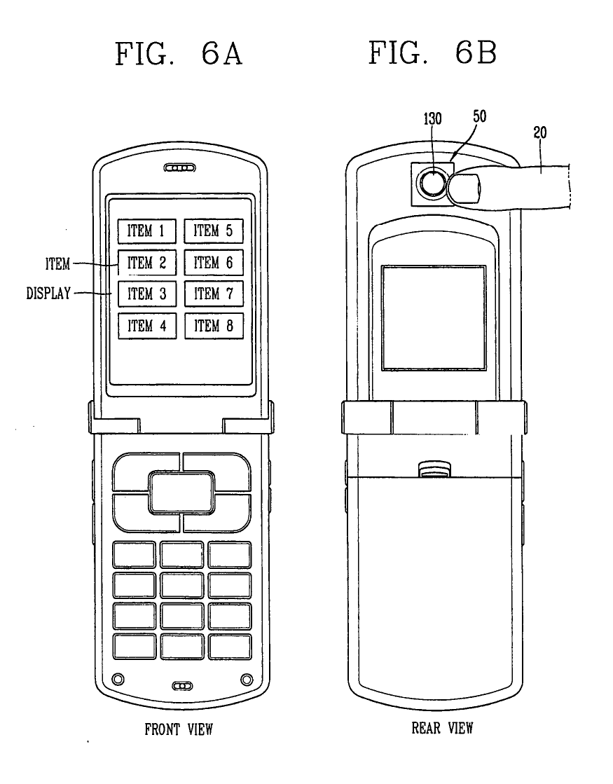

In addition, the input unit 140 and the camera 130 may be located at separate portions of the terminal. For example, the input unit 140 may be a particular button provided on the terminal such as a direction key or other input/selection key. Alternatively, the input unit 140 may be integrally combined with the camera 130 as illustrated in FIG. 6B, for example. In more detail, FIG. 6B illustrates the input unit being an input button 50 combined with the camera 130. In this example, the input button 50 is a selectable key such as an annular button that surrounds a lens portion of the camera 130 and protrudes above a surface of the lens of the camera 130. Thus, to select a particular item in a menu, the user can simply select the protruding input button 50. Further, other types of buttons, keys, or input devices may be used either separately or combined with the camera 130 to allow the user to select a particular item or option.

In addition, the camera 130 may be a digital camera integrated within the mobile terminal and may be formed on a front or rear side of the terminal. For example, the enclosed figures show the camera 130 disposed on a rear side or back side of a folder portion or flip cover of the terminal. However, the present invention is applicable to mobile terminals and other communication devices (e.g., PDA) having a camera or other type of image capturing device, movement sensor, light detector, etc.

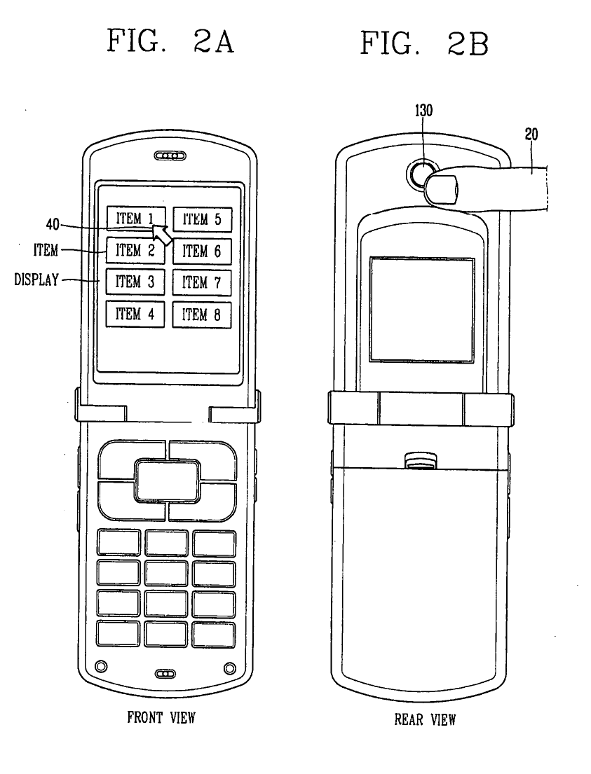

Turning now to FIGS. 2A and 2B, which illustrate a user moving his or her finger in front of a camera lens to thereby move a cursor displayed on a menu screen. FIG. 1 will also be referred to throughout the description of the present invention. In more detail, FIG. 2A illustrates a cursor 40 pointing towards item #1. Thus, the user may move his or her finger 20 in various directions in front of the camera 130, and the camera 130 detects the movement of the user's finger 20. That is, the camera 130 captures images of the user's finger 20 and the processor 120 converts the captured images into coordinate values of the cursor 40 to thereby move the cursor 40 along with movement of the user's finger 20.

In more detail, after the camera 130 captures a first image of the user's finger 20 located at a distance from the camera 130, the camera 130 sequentially captures more images (e.g., a second captured image, a third captured image, etc.) as the user moves his or her finger 20. The processor 120 then converts the digital captured images into analog values corresponding to coordinates of the cursor 40. That is, to convert each captured image into a corresponding coordinate value of the cursor 40, each captured image is defined as a diagnostic element. Then, the processor 120 traces a resolution change of each captured image of the user's finger 20 according to a predetermined rate of image capturing of the camera 130 to thereby extract the coordinate values of the extracted diagnostic elements. The processor 120 then calculates a difference value among the extracted coordinate values to convert the movement of the user's finger 20 into a position change of the cursor 40 moving among items on the menu screen.

In addition, to perform such operation of the processor 120, the camera 130 preferably captures the movement of the user's finger 20 in a state that a constant rate of image capturing is set. For example, based upon experimental results, the camera preferably maintains a rate of image capturing of more than 30 frames per second to capture images of the user's finger 20. Also, a sufficient margin is preferably set for the camera 130 so as to accept image changes even if the user's finger 20 is suddenly captured by the camera or quickly disappears from the camera's view.

The camera 130 having the set rate of image capturing and margin then traces the movement of the user's finger 20 to capture its images, and accordingly the cursor 40 can be moved, shifted or scrolled among the items on the menu screen. That is, the movement of the user's finger 20 in horizontal, vertical, and diagonal directions is sensed by the camera 130 and this movement is translated to a corresponding movement of the cursor 40.

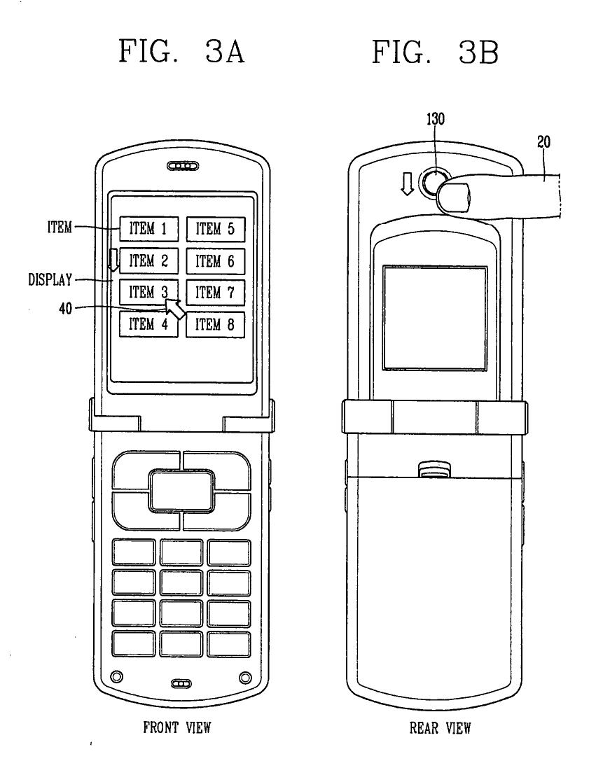

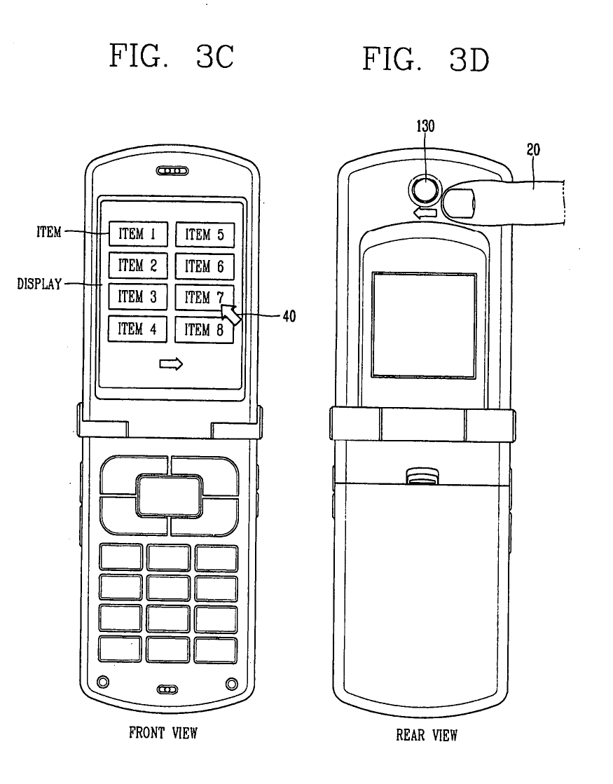

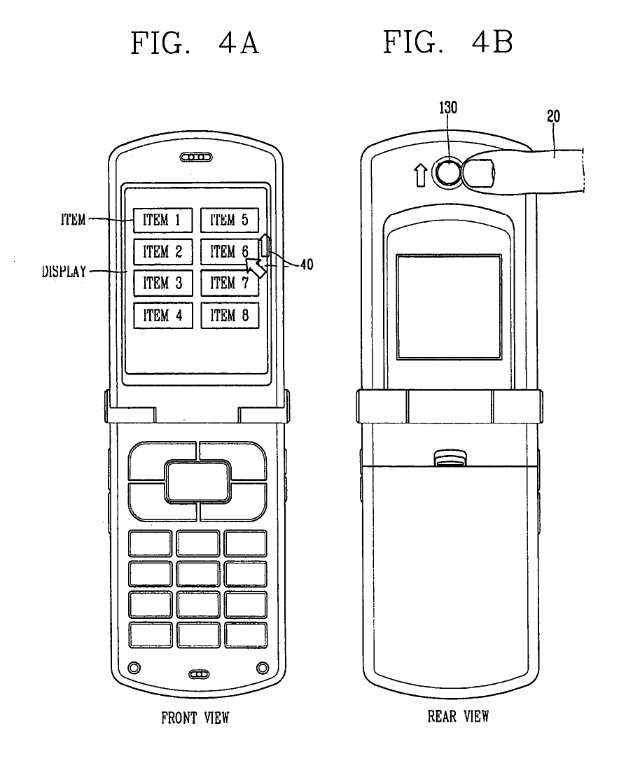

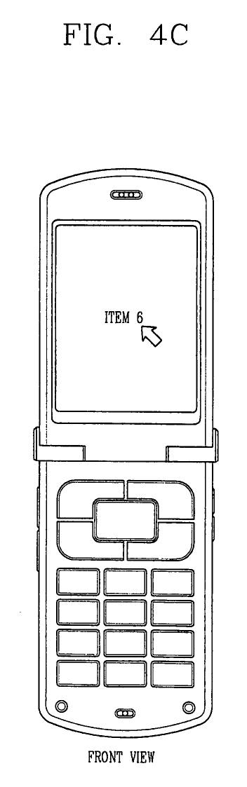

In addition, FIGS. 3A and 3B illustrate the user moving his or her finger 20 in a top-to-bottom direction to thereby move the cursor in a top-to-bottom direction, FIGS. 3C and 3D illustrate the user moving his or her finger 20 in a left direction to move the cursor in a left-to-right direction, and FIGS. 4A and 4B illustrate the user moving his or her finger 20 in a bottom-to-top direction to move the cursor in a bottom-to-top direction. Note, the user can also move his or her finger 20 in a right direction to move the cursor in a right-to-left direction (not shown).

Thus as shown in FIG. 3B, when the user moves his or her finger 20 in a top-to-bottom direction in front of the camera 130, the camera 130 sequentially captures images of the moving finger 20. The captured images are then converted by the processor 120 into coordinate values for the cursor 40 moving among the items on the menu screen. Thus, with reference to FIG. 3A, the user has moved his or her finger 20 in front of the camera 130 in a top-to-bottom direction to move the cursor 40 over the item #3, which will be highlighted. The user may then select the item #3 using the input unit 140.

Similarly, as shown in FIGS. 3C and 3D, the user may move his or her finger 20 in a left direction to move the cursor in a left-to-right direction such that the cursor 40 is displayed over the item #7, which is then highlighted. The highlighted item #7 may then be selected via the input unit 140. Note that because the camera is located on the opposite side of the display, the movement direction of the user's finger 20 and the movement of the displayed cursor in FIGS. 3C and 3D are in opposite directions.

Also, FIGS. 4A and 4B illustrate the user moving his or her finger 20 in a bottom-to-top direction to move the cursor 40 to the upper side of the display (i.e., from item #7 to item #6). The user can thus select the highlighted item #6. FIG. 4C illustrates a display screen when the user selects the item #6. The user may also select the highlighted item via voice recognition techniques (e.g., be speaking “select item” into a microphone provided with the mobile terminal when a particular item is highlighted).

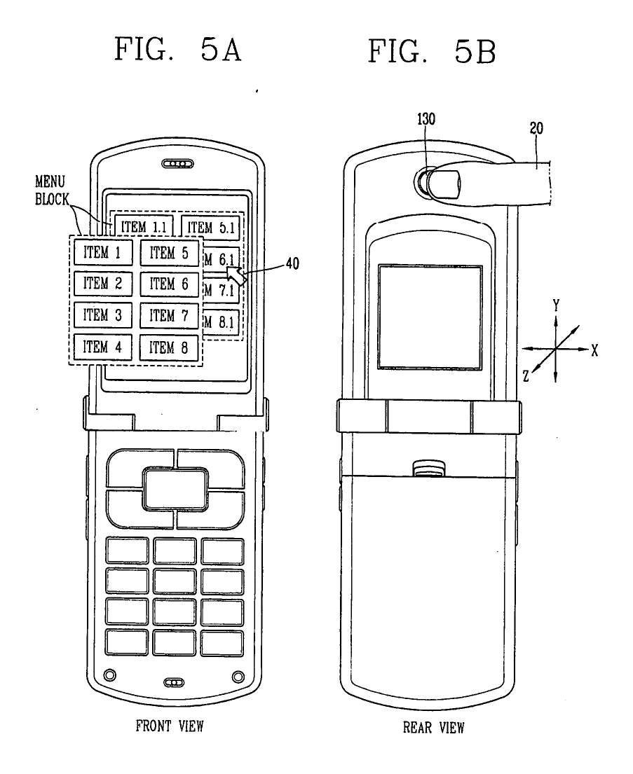

In addition, FIGS. 2-4 illustrate a 2-D GUI in which the cursor 40 is moved in two dimensions including an X-axial direction (or right and left direction) and Y-axial direction (or upper and lower direction). However, as shown in FIG. 5A, the present invention also provides a 3-D GUI including a plurality of menus displayed in 3-D. That is, the present invention provides a menu displayed that has three-dimensional effects, which may also be referred to as 2.5 dimensional effects or displayed in a truly three-dimensional manner such as in virtual reality displays.

In these 3-D examples, the cursor 40 can be moved in three dimensions in response to the movement of the user's finger 20. That is, as shown in FIG. 5B, the user can move his or her finger 20 in the X-axis direction (right and left direction), the Y-axis direction (upper and lower direction), and Z-axis direction (towards and away from the camera 130). In addition, as shown in FIG. 5A, each menu block is constructed as a 2-D GUI menu screen containing a plurality of items (eight items are shown in FIG. 5A). Thus, in such a 3-D menu, the shifting among menu blocks is achieved such that when the user moves his or her finger 20 in the Z-axial direction (i.e., a direction towards or away from the camera 130), the cursor 40 moves from one corresponding menu block to an upper or lower menu block. For example, if the user moves his or her finger 20 away from the camera 130 in the Z-axial direction, the cursor 40 moves from a lower menu block to an upper menu block.

Further, the menu block that the cursor 40 has been moved to may also be highlighted to indicate the menu block has been selected. The user may also move the cursor 40 to a particular item contained in the highlighted menu block by moving his or her finger in the appropriate X or Y directions. The particular item having the cursor displayed on top of it is also highlighted, and the user can select the particular item as discussed above with respect to the 2-D GUI. For example, with reference to FIGS. 5A and 5B, the user may select the item #1 by moving the cursor 40 over the item #1 and pressing the input button 140.

In addition, FIGS. 6A and 6B illustrate the user moving his or her finger 20 in front of the camera 130 and then selecting the input button 50 to select item #1.

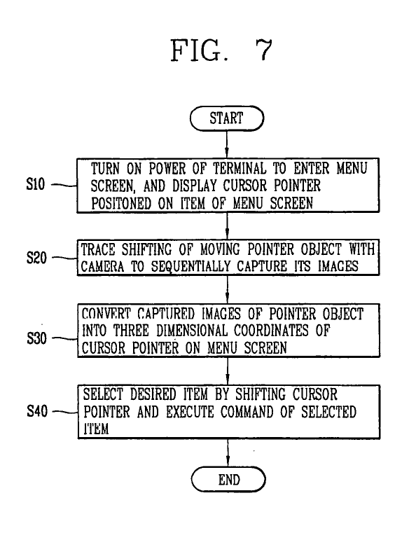

Turning next to FIG. 7, which is a flowchart illustrating a method for moving a cursor on a menu screen and selecting a specific item using a camera in accordance with an embodiment of the present invention. As shown, when the user turns on the power of the terminal and enters a menu screen, the cursor is displayed on the screen at an initial position (S10). Then, the user can move his or her finger in front of the camera to move between items displayed on the menu screen, and the camera traces the movement of the user's finger by sequentially capturing images of the user's finger (S20).

The processor then performs an A/D converting process of the movement (which as discussed above may be a three dimensional movement) of the user's finger captured in the step S20 (S30). The conversion process converts the captured images into appropriate coordinate values of the cursor on the menu screen. The user may then select a desired item by selecting the appropriate input key and the corresponding function is executed (S40).

In addition, a sensitivity or degree of responsiveness to measuring movements of the user's finger in front of the camera is automatically adjusted. For example, if the user places/moves his or her finger very close to the front of the camera, relatively small movements of the user's finger are preferably detected. In contrast, if the user move his or her entire palm or hand at some distance from the camera, then relatively large movements of the user hand are preferably detected. Also, a proximity of the user's finger, the user's entire hand, etc. may be used to determine the type and capability of an appropriate image capture device that may be employed.

Thus, the present invention advantageously provides a 2-D or 3-D GUI that allows the cursor to be moved in a two or three dimensional manner. Further, a distance from the user's finger to the camera is detected to determine a degree of responsiveness to the detected movements. Also, the processor converts relatively small movements of the user's finger into movements of the cursor being displayed on the display device if the user's finger is detected to be relatively close to the detector, and converts relatively large movements of the user's finger into movements of the cursor being displayed on the display device if the user's finger or palm, etc. is detected to be relatively far from the detector.

In addition, the display device of the mobile terminal can be a screen and the detector can be a camera of a wireless communications device that allows communication with a network via a wireless interface. For example, the detector can be an image capturing device, a motion detection device, a light sensor, and/or any combination thereof. The present invention may also include an input button that surrounds the detector and protrudes therefrom to allow user selection thereof, and/or a voice recognition device cooperating with the display device, the detector and the processor to recognize voice commands from the user to allow selection of an item on the GUI on which the cursor has been moved to.

As described so far, in the present invention, the movement of the user's finger placed in front of the camera is converted into a movement of the cursor on the menu screen so as to allow moving and selecting of a menu and items therein, whereby a separate menu shift key or other buttons used for switching or selecting between different menus is not required. Thus, the manufacturing costs related to producing and assembling the mobile terminal can be reduced.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

What is claimed is:

1. A menu input method for a mobile terminal, comprising:
displaying a menu having a plurality of items on a display of the mobile terminal; and
displaying a cursor used to select one of the plurality of items at a first position on the display;
capturing images of a pointer object moving in front of an image capturing device included with the mobile terminal; and
converting the captured images into coordinate values of the cursor and moving the cursor to a second position on the display based on the converted coordinate values.

2. The method of claim 1, wherein the menu is displayed as a two-dimensional (2-D) menu, and the coordinate values of the cursor are two-dimensional (2-D) coordinate values.

3. The method of claim 1, wherein the menu is displayed as a three-dimensional (3-D) menu, and the coordinate values of the cursor are three-dimensional (3-D) coordinate values.

4. The method of claim 3, wherein the three dimensional (3-D) menu contains at least a first menu block having a plurality of first items and a second menu block having a plurality of second items, said second menu block being three-dimensionally displayed above the first menu block.

5. The method of claim 1, wherein the capturing step captures images of the pointer object according to a particular image capturing rate based on how close the pointer object is to the image capturing device.

6. The method of claim 5, wherein the capturing step captures images of the pointer object at a faster image capturing rate when the pointer object is closer to the image capturing device and at a slower image capturing rate when the pointer object is father away from the image capturing device.

7. The method of claim 1, wherein the capturing step captures images of the pointer object moving in vertical, horizontal, and/or diagonal directions.

8. The method of claim 1, wherein the capturing step captures at least first and second images of the pointer object moving in front of the camera, and wherein the converting step comprises:
performing an analog-to-digital conversion process for converting the first and second captured images into first and second analog values;
defining the first and second analog values as first and second diagnostic elements, respectively;
extracting first and second coordinate values corresponding to the first and second diagnostic elements;
extracting a difference value between the first and second coordinate values; and
moving the pointer object over the plurality of items on the menu using the extracted difference value.

9. The method of claim 1, further comprising:
selecting a particular item when the cursor is displayed over the particular item.

10. The method of claim 9, wherein the particular item is selected by a user via an input key that is separate from the image capturing device, an input key surrounding the image capturing device or via a voice recognition process.

11. A mobile terminal, comprising:
a display configured to display a menu having a plurality of items, and to display a cursor used to select one of the plurality of items at a first position on the display;
an image capturing device configured to capture images of a pointer object moving in front of the image capturing device; and
a processor configured to convert the captured images into coordinate values of the cursor and to move the cursor to a second position on the display based on the converted coordinate values.

12. The mobile terminal of claim 11, wherein the menu is displayed as a two-dimensional (2-D) menu, and the coordinate values of the cursor are two-dimensional (2-D) coordinate values.

13. The mobile terminal of claim 11, wherein the menu is displayed as a three-dimensional (3-D) menu, and the coordinate values of the cursor are three-dimensional (3-D) coordinate values.

14. The mobile terminal of claim 13, wherein the three dimensional (3-D) menu contains at least a first menu block having a plurality of first items and a second menu block having a plurality of second items, said second menu block being three-dimensionally displayed above the first menu block.

15. The mobile terminal of claim 11, wherein the image capturing device captures images of the pointer object according to a particular image capturing rate based on how close the pointer object is to the image capturing device.

16. The mobile terminal of claim 15, wherein the image capturing device captures images of the pointer object at a faster image capturing rate when the pointer object is closer to the image capturing device and at a slower image capturing rate when the pointer object is father away from the image capturing device.

17. The mobile terminal of claim 11, wherein the image capturing device captures images of the pointer object moving in vertical, horizontal, and/or diagonal directions.

18. The mobile terminal of claim 11, wherein the image capturing device captures at least first and second images of the pointer object moving in front of the camera, and wherein the processor converts the captured image into the coordinate values by:
performing an analog-to-digital conversion process for converting the first and second captured images into first and second analog values;
defining the first and second analog values as first and second diagnostic elements, respectively;
extracting first and second coordinate values corresponding to the first and second diagnostic elements;
extracting a difference value between the first and second coordinate values; and
moving the pointer object over the plurality of items on the menu using the extracted difference value.

19. The mobile terminal of claim 11, further comprising:
an input unit configured to select a particular item when the cursor is displayed over the particular item.

20. The mobile terminal of claim 19, wherein the input unit is one of an input key that is separate from the image capturing device, an input key surrounding the image capturing device or via a voice recognition process.
